(19) United States
(12) Patent Application Publication
(10) Pub. No.: US 2025/0094891 A1
(43) Pub. Date: Mar. 20, 2025

(54) Automated Input Processing for Machine Learning-Based Task Generation

(71) Applicant: ZEBRA TECHNOLOGIES CORPORATION, Lincolnshire, IL (US)

(72) Inventors: Suvarna S. Krishnan, Westwood, MA (US); Sriram Krishnan, Sharon, MA (US)

(21) Appl. No.: 18/369,019

(22) Filed: Sep. 15, 2023

(51) Int. Cl. G06Q 10/0631

(52) U.S. Cl. CPC G06Q 10/06311

(57) ABSTRACT

A method includes: detecting a plurality of events corresponding to operational disruptions for a facility, each event including one of a predetermined set of disruption type identifiers; retrieving configuration data defining, for each disruption type identifier, a set of impact attributes; determining, for each event, an impact score based on the set of impact attributes; generating, for each event, an exception record encoding the disruption type identifier and the impact score; sorting the exception records according to the impact scores; and providing the exception records, sorted according to the impact scores, to a task generator configured to output at least one task for responding to the operational disruptions.

### BACKGROUND

The operation of facilities such as retailers, warehouses, and the like, may involve the performance of tasks by staff at such facilities. Some tasks may be performed in response to a wide variety of events, such as disruptions to regular operations (e.g., spills or the like). Such disruptions may occur at unpredictable times, and multiple disruptions may exist simultaneously. Selecting which tasks to perform at which times may therefore be computationally difficult, and may instead be performed subjectively by the staff.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a system for automated input processing for machine learning-based task generation in a facility.

FIG. 2 is a diagram of certain internal components of the computing device of FIG. 1.

FIG. 3 is a flowchart of a method of automated input processing for machine learning-based task generation.

FIG. 4 is a diagram illustrating example configuration data and dependency data retrieved at block 305 of the method of FIG. 3.

FIG. 5 is a diagram illustrating an example performance of block 320 of the method of FIG. 3.

FIG. 6 is a diagram illustrating an example performance of block 330 of the method of FIG. 3.

FIG. 7 is a diagram illustrating an example performance of block 340 of the method of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method, comprising: detecting a plurality of events corresponding to operational disruptions for a facility, each event including one of a predetermined set of disruption type identifiers; retrieving configuration data defining, for each disruption type identifier, a set of impact attributes; determining, for each event, an impact score based on the set of impact attributes; generating, for each event, an exception record encoding the disruption type identifier and the impact score; sorting the exception records according to the impact scores; and providing the exception records, sorted according to the impact scores, to a task generator configured to output at least one task for responding to the operational disruptions.

Additional examples disclosed herein are directed to a computing device, comprising: a communications interface; and a processor configured to: detect a plurality of events corresponding to operational disruptions for a facility, each event including one of a predetermined set of disruption type identifiers; retrieve configuration data defining, for each disruption type identifier, a set of impact attributes; determine, for each event, an impact score based on the set of impact attributes; generate, for each event, an exception record encoding the disruption type identifier and the impact score; sort the exception records according to the impact scores; and provide the exception records, sorted according to the impact scores, to a task generator configured to output at least one task for responding to the operational disruptions.

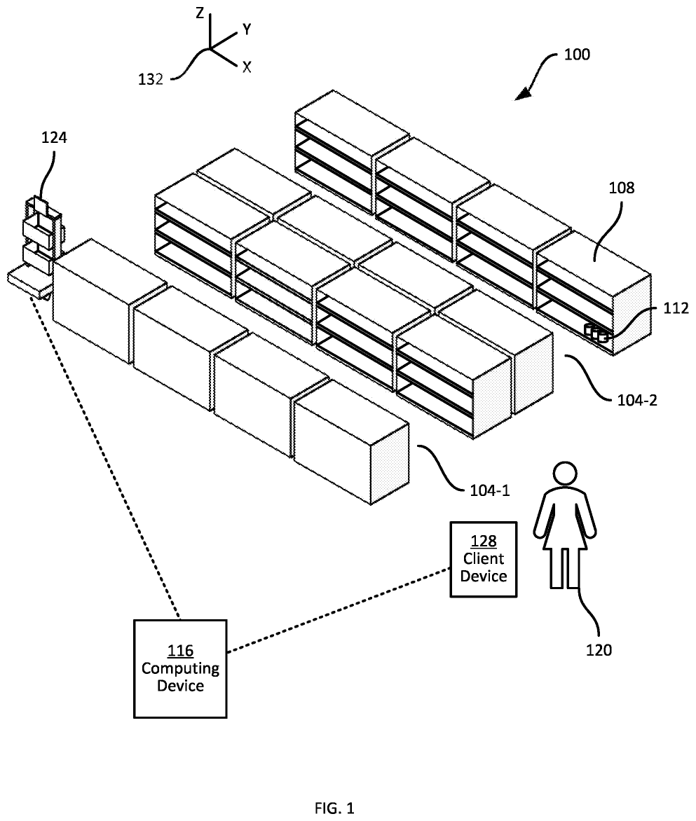

FIG. 1 illustrates a system 100 for automated input processing for machine learning-based task generation. The system 100 can be implemented in a facility such as a retail facility (e.g., a grocer) containing one or more aisles 104-1, 104-2 (also referred to collectively as aisles 104, or generically as an aisle 104; similar nomenclature may also be employed herein for other elements with reference numbers with hyphenated suffixes). The aisles 104 can be formed, as in the illustrated example, by support structures such as shelf modules 108, each defining one or more support surfaces (e.g., shelves, peg boards, or the like) for supporting items 112 such as products available for purchase by customers of the retail facility. The system 100 can be deployed in a wide variety of other facilities, including manufacturing facilities, healthcare facilities, warehouses, and the like.

The system 100 includes a computing device 116 configured to obtain tasks to be performed in the facility, and to allocate those tasks to workers deployed in the facility. The tasks can vary with the nature of the facility. For example, tasks allocated to workers in a retail facility as shown in FIG. 1 can include scheduled cleaning tasks, stock picking tasks to collect items 112 for order fulfillment, replenishment tasks to retrieve items 112 from a storage area (not shown) for placement on the shelf modules 108, and the like. The type of the workers deployed in the facility to perform tasks may also vary between facilities. In the illustrated example, the workers can include either or both of human employees 120, and semi- or fully autonomous robots 124. Employees 120 can, for example, carry or otherwise access client computing devices 128, such as smart phones, tablet computers, or the like in communication with the computing device 116. The robots 124 can include on-board computing devices configured to communicate with the computing device 116.

Each of the robots 124 and the client devices 128 can track their locations in the facility, for example, according to a coordinate system 132 established in the facility. The client devices 128 and/or robots 124 can be configured to report tracked locations to the computing device 116, e.g., for use in task allocation functions performed by the computing device 116. In some examples, the system 100 can also include sensors such as wireless beacons or the like in communication with the computing device 116, that the computing device 116 can communicate with to determine locations of the client devices 128 and/or robots 124.

The tasks allocated to workers in the facility by the computing device 116 can be obtained at the computing device 116 from various sources. The sources can include subsystems configured to manage various aspects of the facility, such as a subsystem for monitoring label printers and/or other hardware, a timekeeping subsystem to track worker availability, and the like. Such subsystems can be implemented at the computing device 116, or via distinct computing devices, including via cloud-based platforms connected with the computing device 116 via suitable networks.

Some of the tasks obtained at the computing device 116 may be time-sensitive, e.g., tasks that are responsive to operational disruptions in or associated with the facility. For example, while some tasks may be routine (e.g., scheduled cleaning of certain areas of the facility, processing incoming shipments, and the like), other tasks may be responsive to unplanned disruptions such as spills, staff absences, or the like. Responding to such disruptions may be time-sensitive.

When multiple operational disruptions occur with overlapping time periods (e.g., a staff absence or late arrival, contemporaneously with a receipt printer error and a spill in the facility), there may be insufficient resources (e.g., in the form of available employees 120) to respond to each disruption simultaneously. For example, tasks for responding to the disruptions may be allocated to one employee 120. Determining an order in which to respond to the disruptions may be dependent on the specific combination of disruptions to respond to, as the aspects of the facility affected by each disruption may be dependent on one another in various ways. Further, because the number of disruptions occurring at a given time can vary widely, constructing a rules-based algorithm to allocate and prioritize tasks for responding to disruptions may be computationally impractical. Determining an order in which to address disruptions may therefore rely on subjective human judgement (and consequently human error) in previous systems.

As discussed below, the computing device 116 can therefore implement or otherwise access a machine learning-based prioritization process, e.g., configured to accept data representing disruptions as inputs (e.g., as prompts), and to output an ordered set of tasks for responding to the disruptions. For example, a large language model (LLM) or other generative process can be employed to generate the ordered set of tasks. The use of a generative process may provide greater flexibility than predictive processes, as a generative process may be capable of producing sets of tasks beyond those explicitly appearing in the training data set. The use of a generative process may also reduce or avoid the need to train a classification model with a large number of output classes (e.g., one for each possible combination of disruption-response tasks).

The use of a task generator based on, for example, an LLM, presents certain technical challenges. For example, providing a list of overlapping disruptions (e.g., disruptions beginning simultaneously or within a period of time sufficiently short that each disruption has begun before any has been resolved) to the task generator may yield inaccurate prioritizations. Prioritization can be affected by a variety of attributes of the disruptions, and those attributes may vary dynamically depending on the other disruptions present. The computing device 116 implements data processing functions to generate exception records that encode information about disruptions, including the above attributes. The exception records permit a set of overlapping disruptions to be provided to the task generator in a way that conveys the above attributes and increases the accuracy of the sets of tasks produced by the task generator.

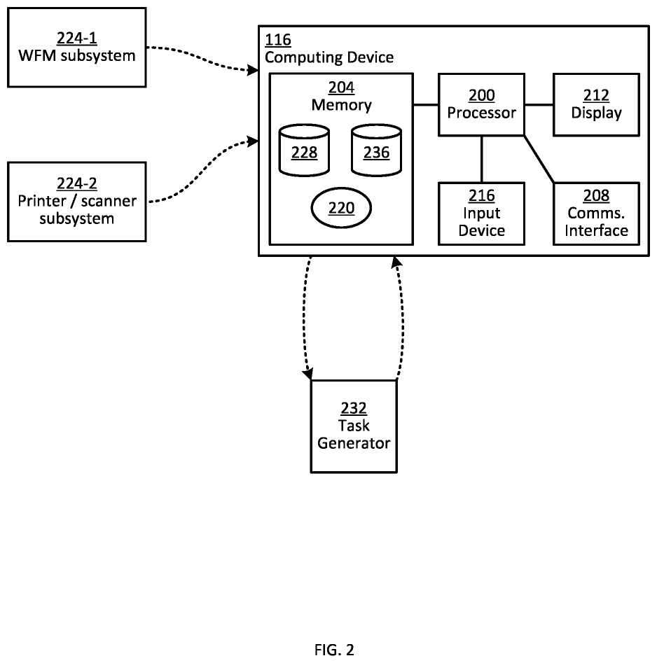

FIG. 2 is a diagram of certain internal components of the computing device 116, and certain interactions of the components of the computing device 116 with other computing devices. The computing device 116 includes a processor 200 (e.g., a central processing unit (CPU), graphics processing unit (GPU), and/or other suitable control circuitry, microcontroller, or the like), interconnected with a non-transitory computer readable storage medium, such as a memory 204. The memory 204 includes a suitable combination of volatile memory (e.g. Random Access Memory or RAM) and non-volatile memory (e.g. read only memory or ROM, Electrically Erasable Programmable Read Only Memory or EEPROM, flash memory). The memory 204 can store computer-readable instructions, execution of which by the processor 200 configures the processor 200 to perform various functions in conjunction with certain other components of the computing device 116. The computing device 116 also includes a communications interface 208 enabling the device 116 to exchange data with other computing devices, e.g. via a wireless local area network deployed in the facility, a combination of local and wide-area networks, and the like.

The device 116 can also include a display 212 and/or other suitable output device, such as a speaker, and an input device 216 such as a keyboard, a mouse, a microphone, and/or other suitable inputs. In other examples, the display 212 and input device 216 are hosted by a separate computing device (not shown), and connected to the computing device 116 via a network and the communications interface 208.

The components of the computing device 116 can be supported in a housing deployed at the facility of FIG. 1, e.g., as a desktop computer, on-site server, or the like. In other examples, the computing device 116 can be implemented in cloud infrastructure, e.g., as a virtual machine executed on computing hardware shared between various other functions.

The instructions stored in the memory 204 include, in this example, an input processing application 220 that, when executed by the processor 200, configures the device 116 to detect operational disruptions and to generate exception records encoding attributes for those disruptions. The operational disruptions can be detected at the device 116 by monitoring data feeds from various other subsystems. Example subsystems 224-1 and 224-2 are illustrated in FIG. 2. The subsystem 224-1 is, in this example, a workforce management (WFM) subsystem configured to track employee schedules and the like. The subsystem 224-2 is a device management subsystem, e.g., configured to track status information of printers, barcode scanners and other peripheral devices in the facility. A variety of other subsystems 224 can also be connected with the device 116, in addition to or instead of the subsystems 224 shown in FIG. 2.

The device 116 maintains, e.g., in a repository 228, configuration data according to which events are detected via data feeds provided by the subsystems 224. The configuration data defines, as discussed further below, dependencies between the subsystems 224 and/or software applications and hardware deployed at the facility and monitored by the subsystems 224. The configuration data in the repository 228 can also include predetermined priority levels for the above software applications, hardware, or the like. The configuration data 228 is employed by the device 116 to generate exception records from the data feeds of the subsystems 224. The exception records can then be provided to a task generator 232, such as a further computing device executing an LLM. The task generator 232 can be configured, using the exception records as prompts, to generate a prioritized set of tasks for responding to the disruptions, which can then be returned to the device 116 for storage in a repository 236, and/or allocation to one or more workers, e.g., via client devices 128.

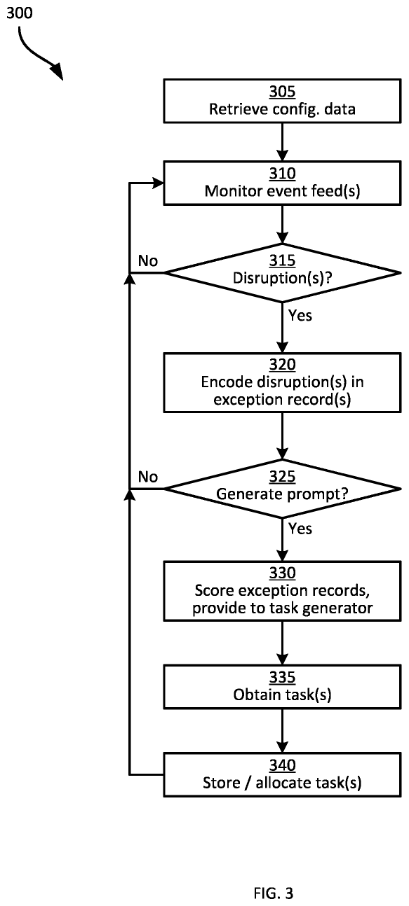

Turning to FIG. 3, a method 300 of automated task allocation is illustrated. The method 300 is described below in conjunction with its performance by the device 116, via execution of the application 220 by the processor 200.

At block 305, the device 116 can be configured to load configuration data, e.g., from the repository 228. The configuration data includes information permitting the device 116 to retrieve event data from the subsystems 224, and in some implementations to filter the event data from the subsystems 224 to detect certain events corresponding to operational disruptions, while ignoring or discarding other events that do not correspond to operational disruptions. For example, the configuration data can include network identifiers (e.g., IP addresses or the like) of the subsystems 224, API commands for retrieving data from the subsystems 224, and/or subscription settings defining certain subsets of the event data generated by each subsystem 224 to be retrieved by the device 116 or pushed to the device 116.

The configuration data can also include, as discussed below, information used by the device 116 to process the event data to generate inputs for the task generator 232. Such information includes impact attributes for events corresponding to operational disruptions. The impact attributes for a given disruption can include predetermined attributes such as a priority level, and a dependency count indicating how many other aspects of the facility are dependent on the aspect associated with the disruption. The priority level and dependencies can be substantially static, e.g., changing infrequently by reconfiguration of the system 100. The impact attributes can also include dynamically updated attributes such as an event frequency, e.g., indicating a number of occurrences of a given event over a predetermined time period such as the previous month, year, or the like.

At block 310, the device 116 is configured to monitor event data from the subsystems 224. For example, the device 116 can be configured to subscribe to certain disruption types, according to the configuration data. In other examples, the device 116 can retrieve event data periodically from the subsystems 224, which may include both events corresponding to disruptions and events that do not correspond to disruptions. The frequency with which event data is pulled by the device 116 from the subsystems 224, or pushed to the device 116 by the subsystems 224, can be selected to permit the device 116 to detect events substantially in real-time. For example, the frequency with which event data is obtained at the device 116 can be selected such that a delay between event data becoming available at a subsystem 224 and the event data being obtained at the device 116 remains below about ten seconds. A wide variety of other time periods can also be employed however, e.g., to balance currency of data with bandwidth and storage resources.

At block 315, the device 116 is configured to determine whether the event data monitored at block 310 includes operational disruptions as indicated in the configuration data. When the determination at block 315 is negative, the device 116 can continue monitoring event data at block 310. When the determination at block 315 is affirmative, the device 116 proceeds to block 320.

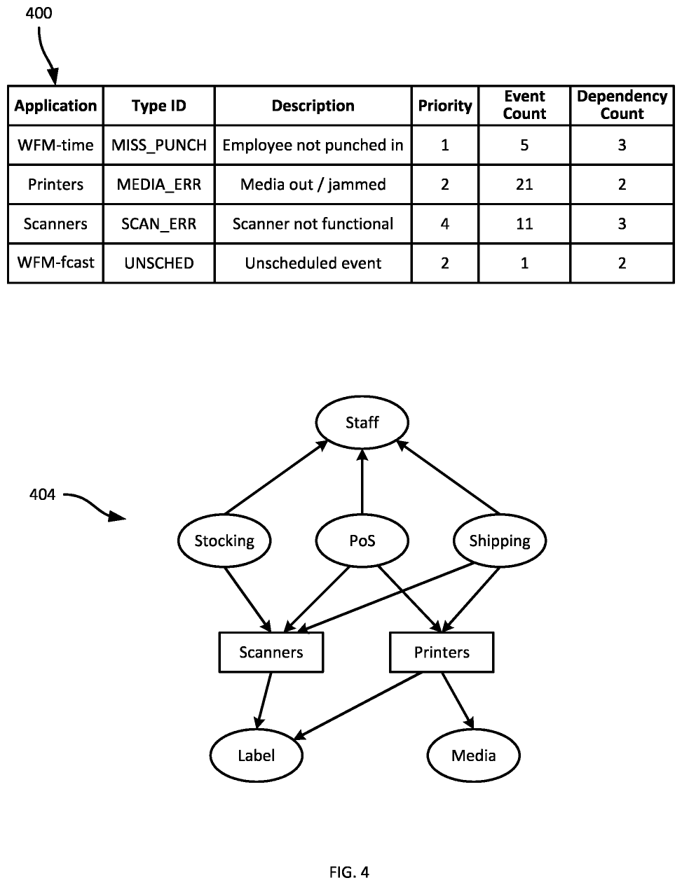

Turning to FIG. 4, example configuration data 400 is shown, according to which the device 116 detects disruption-related events at block 315. The configuration data 400 includes a plurality of records (illustrated as rows in FIG. 4, although other suitable formats can also be employed for storing the configuration data 400), each corresponding to a type of operational disruption. Each record identifies an application associated with the disruption. The application identified (in the first column of each record, in this example) indicates a subsystem 224, or a component of a subsystem 224. For example, the application “WFM-time” corresponds to a timekeeping and staff scheduling function implemented by the subsystem 224-1, and the application “WFM-fcast” corresponds to an event or staffing forecasting function implemented by the subsystem 224-1. The application “printers” can correspond to a printer (e.g., label printers and the like in the facility) monitoring function implemented by the subsystem 224-2, and the application “scanners” can correspond to a scanner (e.g., handheld barcode scanners, presentation scanners and the like in the facility) monitoring function implemented by the subsystem 224-2. The application identifiers can include API calls, an IP address, or other information permitting the device 116 to request and/or receive data from the corresponding subsystems 224.

Each record of the configuration data also includes a disruption type identifier, corresponding to identifiers included in the data received from the subsystems 224. For example, the type “miss_punch” indicates that the subsystem 224 has detected that an employee 120 scheduled to come on shift has not punched in (e.g., may not be present for their shift). The type “media_err” may indicate that a printer has run out of media, has a media jam, or the like. The type “scan_err” may indicate that a barcode scanner has crashed, lost power, or the like. The type “unsched” may indicate that an unplanned event has been identified, such as a tour bus arriving at the facility, which is expected to result in a short-term increase in customer volume. A wide variety of other disruption types will also occur to those skilled in the art. The subsystems 224 may also produce event data corresponding to other event types, such as indications that print jobs have completed, that employees 120 have arrived on shift, and the like. The configuration data 400 in this example does not identify those (e.g., non-disruptive) events, and such event data may therefore not be retrieved by the device 116, or may be ignored or discarded by the device 116 upon receipt.

The configuration data can also include a description of each disruption type, e.g., to indicate the nature of the corresponding event types to an operator of the system 100. The configuration data 400 further includes a set of impact attributes for each disruption type. In this example, the impact attributes include a priority level, e.g., with “1” indicating higher priority and “4” indicating lower priority. The impact attributes can also include an event count, such as the number of events of the corresponding type detected over a predetermined time period (e.g., the previous month).

The configuration data 400 can also include an impact attribute indicating a dependency count for each disruption type. The dependency count indicates a number of other applications whose functionality is dependent on the application indicated in the record of the configuration data 400. For example, the configuration data 400 indicates that four other applications are dependent on the WFM-time application.

The dependency counts of the configuration data 400 can be updated by the device 116 from a dependency graph, e.g., stored at the device 116 as a JavaScript Object Notation (JSON) tree, or the like. That is, the device 116 can be configured to monitor the dependency graph for changes, e.g., made by an operator of the system 100, and can update the dependency counts in the configuration data as necessary.

An example dependency graph 404 is shown in FIG. 4. Nodes in the dependency graph correspond to applications in the configuration data, and/or to other physical assets in the facility, such as labels appearing on the items 112 and media consumed by printers in the facility. In the example shown in FIG. 4, the dependency graph indicates that the “staff” node (corresponding to the WFM-time application) has three dependencies, reflective of the need for an employee 120 to operate printers and scanners, and perform stocking tasks. The scanners application is shown as having three dependencies, reflecting that stocking, point-of-sale, and shipping functions are dependent on scanner availability. The printers application is shown as having two dependencies, reflecting that point-of-sale and shipping functions are dependent on printer operations. As will be understood, a wide variety of other dependency graphs can also be constructed, depending on the nature of the facility. The number of edges indicating a dependency on a given node (e.g., arrows pointing towards the node, in the illustrated example) defines the dependency count in the configuration data 400.

Returning to FIG. 3, following an affirmative determination at block 315, the device 116 is configured to encode each disruption detected at block 315 in an exception record. In other examples, generation of an exception record can be delayed until an affirmative determination at block 325, and at block 320 the event data defining each detected disruption can be stored in the memory 204 without generating exception records.

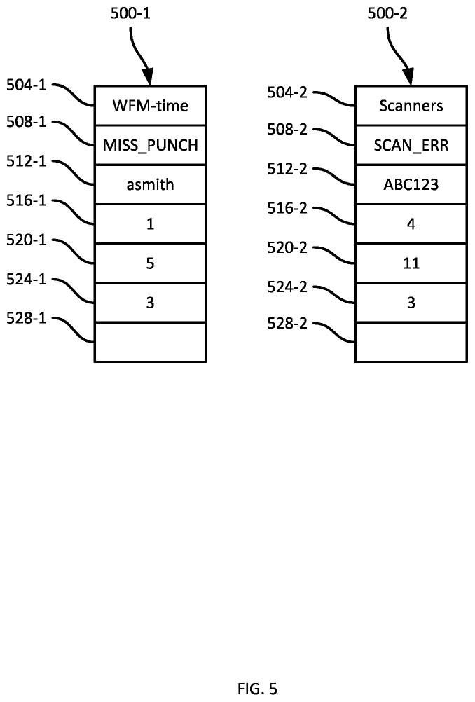

The device 116 is configured to generate exception records according to a predetermined schema, used for every disruption type represented in the configuration data 400. The use of a common structure for exception records permits the device 116 to combine arbitrary numbers of exception records, representing arbitrary numbers and types of disruptions, into prompt data for the task generator 232. Turning to FIG. 5, example exception records 500-1 and 500-2 are illustrated, corresponding respectively to a missed punch-in event, and a scanner error event. Each of the records 500-1 and 500-2 can be generated as one-dimensional arrays, with various attributes in a predetermined order. In the illustrated example, each record 500 includes an application identifier 504 and a disruption type 508. Each record 500 also includes an event-specific identifier, such as an employee identifier “asmith” in the case of a missed punch-in event, and a scanner device identifier (e.g., a media access control address, serial number, or the like) in the case of a scanner error event.

Each record further includes impact attributes obtained from the configuration data 400 (e.g., not necessarily received from the subsystems 224) by matching the event data from the subsystems 224 to the configuration data 400. The impact attributes include, in this example, a priority level 516, an event count or frequency 520, and a dependency count 524. In addition, each record 500 includes an impact score value 528. As shown in FIG. 5, the score values are currently blank. The impact score values permit arbitrary combinations of events to be prioritized relative to each other, and are therefore generated when a set of exception records is combined for provision to the task generator 232.

The exception records 500 as shown in FIG. 5 contain both numerical values and text strings. In other examples, the records 500 can be generated as numerical vectors, e.g., by one-hot encoding the textual fields and/or performing an embedding process to encode the textual fields numerically.

Returning to FIG. 3, at block 325 the device 116 is configured to determine whether to generate prompt data for the task generator 232. The device 116 can, for example, generate prompt data for the task generator 232 at a predetermined frequency. The frequency can be selected to bundle disruptions into sets in which each disruption in the set is unlikely to be resolved before the next disruption began. For example, the frequency can be between one minute and ten minutes, although various other frequencies can also be used. It will be understood that an elevated frequency (e.g., below thirty seconds) may lead to the generation and allocation of multiple competing tasks to an employee 120. Bundling exceptions together may permit the system 100 to respond to disruptions substantially in real time, while also addressing disruptions occurring close together in time and thereby prioritizing those disruptions relative to each other more effectively than addressing each disruption individually in sequence.

The determination at block 325 can therefore include determining whether a predetermined time period has elapsed since the previous generation of prompt data via the performance of block 330, discussed below. When the determination at block 325 is negative, the device 116 is configured to return to block 310. The device 116 may therefore accumulate a plurality of exception records before an affirmative determination at block 325.

When the determination at block 325 is affirmative, the device 116 proceeds to block 330. At block 330, the device 116 is configured to retrieve any accumulated exception records generated via block 320 since the previous performance of block 330. The device 116 is configured to determine an impact score for each exception record. The impact score for a given exception record is based on the impact attributes of the corresponding disruption, and can also be based on the impact attributes of the disruptions represented by the other exception records. The impact score indicates the severity of impact on operations at the facility of a given event while accounting for the context in which the event has occurred. The impact score, in other words, is a dynamic priority indicator, distinct from the priority levels in the configuration data, which are substantially static for each disruption type.

Determining an impact score for an event can include calculating the impact score according to equation 1 below:

$$IS = \frac{\frac{{F}_{d} \times {D}_{d}}{{\sum }_{i = 1}^{n} ( {F}_{i} \times {D}_{i} )} \times 100}{{P}_{d}} \qquad Equation 1$$

In equation 1, IS is the impact score for a given disruption d. F_{d} is the frequency or event count for the disruption, D_{d} is the dependency count for the disruption, and P_{d} is the priority level for the disruption. F_{d}, D_{d}, and P_{d} can be retrieved from the configuration data or the exception record for the corresponding disruption. Fᵢ and Dᵢ are the frequency and dependency counts for each exception record among those retrieved at block 330, including the exception record to which the score IS corresponds. The impact score, in other words, represents the weight of the frequency and dependency count of the current exception record in comparison with the combined frequency and dependency counts of all the exception records being processed via the current performance of block 330. That relative weight is then modified according to the priority level of the current exception record, such that disruptions with lower priority (e.g., a value of ‘4’ rather than a value of ‘1’) receive smaller impact scores. Various other operations for determining impact scores can be employed, beyond the equation set out above, to implement the objectives of weighing the impact attributes of each event against the other events under consideration.

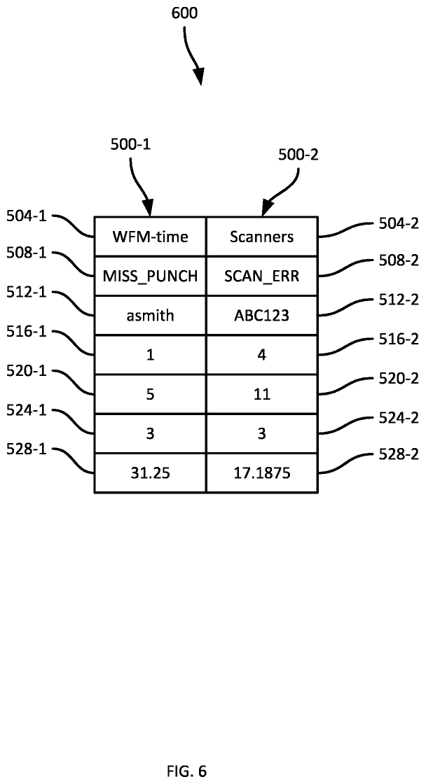

Turning to FIG. 6, the exception records 500-1 and 500-2 are shown with the score values 528-1 and 528-2 completed according to equation 1 above. At block 330 the device 116 can also combine the exception records to generate a prompt record 600, such as a two-dimensional array generated by concatenating the one-dimensional arrays of the exception records 500. As shown in FIG. 6, the records 500-1 and 500-2 can also be sorted according to the impact scores, e.g., placing the record 500 with the highest impact score in the first column of the record 600 and the remaining records 500 arranged in descending order of impact scores towards the right. In the event that two or more records 500 have the same impact scores, the records 500 can be sorted according to their priority levels, e.g., beginning with the highest priority (e.g., the value “1”).

The device 116 is configured to provide the prompt record 600 to the task generator 232 at block 330. The prompt record 600 can also include various other information in some examples, such as system state attributes including a number of staff currently active in the facility, documentation for the applications represented in the records 500 (e.g., a troubleshooting manual for a barcode scanner, corresponding to the record 500-2), and the like.

The task generator 232 is configured, responsive to receiving the prompt record 600, to generate one or more tasks for responding to the operational disruptions represented by the exception records 500. The task generator 232 can, for example, implement an LLM trained on a corpus of exception records (and, optionally, additional information such as documentation, current staffing levels, and the like) labelled with tasks performed as result of the disruptions and other system state parameters indicated by the exception records in the corpus.

At block 335, the device 116 can be configured to receive the task(s) generated by the task generator 232, e.g., as an ordered sequence if there are more than one task. The number of tasks generated by the task generator 232 need not match the number of exception records 500 provided to the task generator 232 at block 330. At block 340, the device 116 is configured to store the tasks received from the generator 232, e.g., in the repository 236. The device 116 can also store the prompt record 600 that lead to the received tasks in the repository 236. The combination of prompts and resulting tasks can be used for further training of the task generator 232, and/or for trend detection and further automated task generation or the like. The device 116 can store the tasks and prompt data in association with a location of the facility, such as a facility identifier, when the computing device 116 is configured to perform the method 300 for event data relating to multiple facilities.

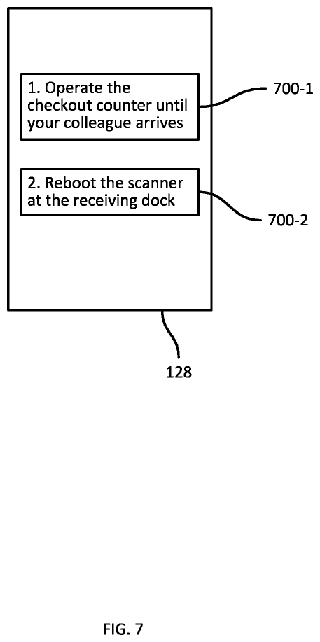

FIG. 7 illustrates example actions 700-1 and 700-2 received from the task generator 232 in response to the prompt record 600. The actions 700 are ordered to indicate that the task 700-1 be performed prior to the task 700-2, given that the tasks 700 have been allocated to a single employee 120 (e.g., via a single client device 128) and therefore will be performed in sequence. The device 128 can collect input data, such as selections of the tasks 700 received via a touch screen, keypad, or the like, indicating completion of a task 700 or the like. The input data can also be stored in the repository 236 along with the tasks 700, the record 600, and the records 500. The combination of data in the repository 236 for a given set of disruptions handed via a performance of blocks 330-340 can be used to further train the LLM implemented by the task generator 232.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method, comprising:
detecting a plurality of events corresponding to operational disruptions for a facility, each event including one of a predetermined set of identifiers;
retrieving configuration data defining, for each identifier, a set of attributes;
determining, for each event, a score based on the set of attributes;
generating, for each event, an exception record encoding the identifier and the score;
sorting the exception records according to the scores; and
providing the exception records, sorted according to the scores, to a task generator configured to output at least one task for responding to the operational disruptions.

2. The method of claim 1, further comprising:
obtaining, from the task generator, the at least one task; and
transmitting the at least one task to a client computing device.

3. The method of claim 1, wherein detecting the events includes:
maintaining configuration data defining the predetermined set of identifiers; and
monitoring event data from at least one operational subsystem for events having one of the predetermined set of identifiers.

4. The method of claim 1, further comprising:
storing the exception records upon generation; and
sorting the exception records according to the scores in response to expiry of a predetermined time period.

5. The method of claim 1, wherein the attributes include at least one of: a priority level, an event frequency, or a dependency count.

6. The method of claim 1, wherein determining the score is based on the set of attributes and the sets of attributes corresponding to each of the plurality of events.

7. The method of claim 6, wherein determining the score for a first one of the events includes determining a ratio of a first value based on the set of attributes corresponding to the first event, and a second value based on a combination of the sets of attributes for each of the events.

8. The method of claim 1, wherein the exception records are one-dimensional arrays; and wherein providing the exception records to the task generator includes concatenating the one-dimensional arrays in descending order of scores.

9. A computing device, comprising:
a communications interface; and
a processor configured to:
detect a plurality of events corresponding to operational disruptions for a facility, each event including one of a predetermined set of identifiers;
retrieve configuration data defining, for each identifier, a set of attributes;
determine, for each event, a score based on the set of attributes;
generate, for each event, an exception record encoding the identifier and the score;
sort the exception records according to the scores; and
provide the exception records, sorted according to the scores, to a task generator configured to output at least one task for responding to the operational disruptions.

10. The computing device of claim 9, wherein the processor is further configured to:
obtain, from the task generator, the at least one task; and
transmit the at least one task to a client computing device.

11. The computing device of claim 9, wherein processor is configured to detect the events by:
maintaining configuration data defining the predetermined set of identifiers; and
monitoring event data from at least one operational subsystem for events having one of the predetermined set of identifiers.

12. The computing device of claim 9, wherein the processor is further configured to:
store the exception records in a memory upon generation; and
sort the exception records according to the scores in response to expiry of a predetermined time period.

13. The computing device of claim 9, wherein the attributes include at least one of: a priority level, an event frequency, or a dependency count.

14. The computing device of claim 9, wherein the processor is configured to determine the score based on the set of impact attributes and the sets of impact attributes corresponding to each of the plurality of events.

15. The computing device of claim 14, wherein the processor is configured to determine the score for a first one of the events by determining a ratio of a first value based on the set of attributes corresponding to the first event, and second value based on a combination of the sets of attributes for each of the events.

16. The computing device of claim 9, wherein the exception records are one-dimensional arrays; and wherein the processor is configured to provide the exception records to the task generator by concatenating the one-dimensional arrays in descending order of scores.
